(19) United States
(12) Patent Application Publication
(10) Pub. No.: US 2010/0241957 A1
(43) Pub. Date: Sep. 23, 2010

(54) SYSTEM WITH DDI PROVIDING TOUCH ICON IMAGE SUMMING

(75) Inventors: Hyoung Rae KIM, Hwasung-si (KR); Yoon Kyung CHOI, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/727,398

(22) Filed: Mar. 19, 2010

(30) Foreign Application Priority Data
Mar. 19, 2009 (KR) 10-2009-0023448

(51) Int. Cl. G06F 3/01; G06F 3/041

(52) U.S. Cl. 715/702; 345/173

(57) ABSTRACT

A data processing system having a display incorporating a touch screen, a constituent display driver (DDI) and method of display an image including a touch icon are disclosed. The DDI receives image data principally defining the display data defining the image on the display and separately receives touch icon image data defining the touch icon within the image. The image data and the touch icon image data are combined in the DDI to generate the display data provided to the display.

### CROSS-REFERENCE TO RELATED APPLICATION

This U.S. non-provisional patent application claims priority under 35 U.S.C. §119 to Korean Patent Application No. 10-2009-0023448 filed Mar. 19, 2009, the subject matter of which is hereby incorporated by reference.

### BACKGROUND

The present disclosure relates to data processing systems. More particularly, the disclosure relates to data processing systems including display driver integrated circuits (DDIs) facilitating the display of image data including one or more touch icons.

The expanding field of data processing systems increasingly uses so-called “virtual” user interfaces in place of traditional, hardwired input/output (I/O) devices. Mechanical keyboards are being replaced with virtual keyboards and hardwired mouse devices are being replaced with displays enabled with touch screen input capabilities. Such replacements are driven by a recognition that conventional user interfaces suffer from a number of limitations including large size and inflexibility of application. These limitations are particularly manifest in relation to emerging electronic devices which are smaller and more portable than their commercial predecessors. As a result, virtual user interfaces are increasingly incorporated into contemporary electronic devices, such as laptop Personal Computers (PCs), Personal Digital Assistants (PDAs), tablet PCs, mobile phones, digital music players, GPS navigators, etc.

One particularly advantageous approach to the implementation of virtual user interfaces is the use of touch screen enabled displays. A “touch screen enabled display” is essentially a display having an incorporated screen (externally overlaying of internally integrated) that enables the entry of user-defined touch data in relation to image(s) presented on the display. Touch screen enabled displays may be implemented using several of different technologies, including resistive, capacitive, optical, inactive, infrared and surface acoustic wave.

Capacitive type touch screen displays (or touch screen panels—TSPs) enjoy performance and implementation benefits over competing technologies. Capacitive TSPs are highly stable, allow high data throughput, and enable multiple input modes of data input. Published U.S. Patent Publication 2007/0273560 describes one example of a capacitive TSP and is hereby incorporated by reference.

More generally, touch screen enabled displays of all types enable system users to directly input “touch data” through a constituent touch screen arranged over or within a display. Touch data may be entered via a variety of user gestures on the surface of the touch screen. The term “touch data” is used to broadly denote any user-defined input communicated via a touch screen. Touch data may be generated using a number of different user input devices (i.e., a finger or stylus) and may be received and interpreted through a variety of different circuits depending on the enabling technology of the touch screen (e.g., optical, capacitive, resistive, etc.).

In foregoing context a “gesture” is any user contact with the touch screen sufficient to coherently communicate data to sensing circuitry associated within the touch screen. Common gestures include tapping, swiping, dragging, pushing, extended dragging, variable dragging, etc. The electrical detection and interpretation of user gestures communicated via a touch screen is a matter of some considerable ongoing research and development. Examples of systems adapted to receive, detect and interpret user gestures communicated via a capacitive touch screen panel include, for example, U.S. Pat. No. 5,880,411 and U.S. patent application Ser. No. 12/635,870 filed Dec. 11, 2009, the collective subject matter of which is hereby incorporated by reference.

Regardless of the particular gesture used or the corresponding detection and interpretation circuitry, most user gestures are made in relation to image data presented on a display associated with the touch screen. For example, a display might illustrate various graphical user interfaces (GUIs) such as a virtual keyboard complete with animated keyboard buttons, a number-pad, a drop-down menu, etc. Each interactive element in a displayed GUI is susceptible to touch data entry via corresponding locations on the touch screen. Thus, “tap” touch data may be entered at a location on a touch screen overlaying an animated number-pad key and be subsequently detected and interrupted as a particular data entry.

Many user gestures (and corresponding touch data entry via the touch screen) are made in relation to displayed icons. Icons are well known in the field of data processing systems. An “icon” is a graphic symbol animated on a display to suggest an object type, a selection type, or an available data processing function. Perhaps the most common icon confronted in everyday use is the cursor indicating a present data entry point, such as those commonly associated with a spreadsheet or word processing application. Blinking vertical or horizontal line segments, circles, crosses, circles with crosses, and intensity fluctuating dots are all commonly used icons.

In the context of displays incorporating a touch screen, icons are referred as “touch icons” because they usually indicate one or more locations at which touch data may be validly entered by a user. Touch icons may be single point indications or more geometrically complex animations. Indeed, whole drawings, drawing segments, lines, and complex images may be moved, manipulated or interacted with as one or more touch icons. User gestures may be directly detected and interpreted in relation to a touch icon (e.g., tapping an icon representing a single point indication, such as a button), or indirectly interpreted (e.g., continuously pulling a finger across the touch screen to draw a line segment above the finger on the display). Some display animations made in response to a user gesture may be amplified or reduced in magnitude (e.g., a drawing segment or stylus write operation may result in a smaller or larger image on the display relative to the actual touch data). Those skilled in the art will recognize a broad range of icon types and usages, as well as data processing functions and capabilities that benefit from the incorporation or use of touch icons.

Unfortunately, the incorporation and use of touch icons within data processing systems comes at some significant computational and/or resource depleting overhead. This is particularly true as touch icons and GUIs incorporating touch icons become more complex and user-interactive, such as moving touch icons, transient or conditional touch icons, and visually compelling touch icons. So long as touch icons were small, simple or used in conjunction with large plug-in data processing systems such as desk top computers, the corresponding system overhead associated with touch icon use was deemed generally acceptable. However, with the migration of data processing systems into smaller, portable, and battery-powered devices, and with more extensive use of complex touch icons, the corresponding imposition on limited system resources (i.e., power, data transfer bandwidth and computational cycles) required to facilitate the use and incorporation of touch icons warrants serious additional consideration.

### SUMMARY

In accordance with one embodiments of the inventive concept, a display driver (DDI) adapted for use with a touch screen enabled display includes; a first memory configured to receive and store image data, a second memory configured to receive and store, separate from the image data, touch icon image data, wherein the DDI is configured to combine the image data and the touch icon image data to generate display data applied to the display.

The DDI may further include an image summing unit configured to receive and combine the image data from the first memory and the touch icon image data from the second memory, and a driver configured to receive the combined image data and touch icon image data from the image summing unit and generate the display data.

In a related aspect, the image summing unit may include an address controller configured to receive and correlate coordinate data associated with the touch icon with the visual touch icon image data to generate the touch icon image data, and an image summing circuit configured to receive and combine the image data and the touch icon image data.

In another embodiment of the inventive concept, a single chip integrated circuit (IC) adapted for use with a touch screen enabled display includes; a touch screen controller (TSC) configured to receive sensor data from the touch screen, and a display device (DDI). The DDI includes; a first memory configured to receive and store image data, a second memory configured to receive and store, separate from the image data, touch icon image data, wherein the DDI is configured to combine the image data and the touch icon image data to generate display data transferred to the display.

In another embodiment of the inventive concept, a method of generating display data in a display driver (DDI) is provided. The display data defines an image including a touch icon and is subsequently displayed on a touch screen enabled display. The method includes; receiving in the DDI image data principally defining the display data, receiving in the DDI, separate from the image data, touch icon image data defining the touch icon, and combining the image data and the touch icon image data in the DDI to generate the display data.

The method may further include, prior to combining the image data and touch icon image data, storing the image data in a first memory in the DDI and storing at least a portion of the touch icon image data in a second memory in the DDI.

The method may still further include generating the image data in a host controller connected to the DDI, and generating the touch icon image data in the host controller and storing the touch icon image data in the second memory.

In another embodiment of the inventive concept, a data processing system includes; a touch screen enabled display configured to receive user-defined touch data, a host controller configured to generate image data, and a display driver (DDI) configured to generate display data controlling generation of an image including a touch icon on the display by combining the image data with touch icon image data defining the touch icon within the image.

The foregoing data processing system may further include a touch screen controller (TSC) configured to receive sensor data from the touch screen in response to the touch data and derive coordinate data identifying a location of the touch data on the touch screen, wherein the host controller (or a related graphics engine) is further configured to receive the coordinate data and generate the touch icon image data in response to the coordinate data.

In yet another embodiment of the inventive concept, a data processing system includes; a display panel incorporating a touch screen panel configured to receive user-defined touch data, a host controller configured to generate image data, a display controller configured to generate display data defining an image including a touch icon presented on the display panel by combining the image data with touch icon image data defining the touch icon within the image, a first plurality of drivers arranged on one side of the display panel and configured to receive the display data, and a second plurality of drivers arranged on another side of the display panel and configured to receive the display data.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a conventional data processing system incorporating a touch screen display.

FIG. 2 is a flowchart summarizing a computational transfer of image data including touch icon image data through a conventional data processing system, such as the one illustrated in FIG. 1.

FIG. 3 is an active resource graph showing corresponding active states for major system components of the conventional data processing system shown in FIG. 1.

FIG. 4 is a block diagram of a display device integrated circuit (DDI) according to an embodiment of the inventive concept.

FIG. 5 is a block diagram of a display device integrated circuit (DDI) according to another embodiment of the inventive concept.

FIG. 6 is a block diagram of a display device integrated circuit (DDI) according to yet another embodiment of the inventive concept.

FIG. 7 is a block diagram of a display device integrated circuit (DDI) according to still another embodiment of the inventive concept.

FIG. 8 is a block diagram of a single chip integrated circuit (IC) embodiment incorporating a display device integrated circuit (DDI) according to an embodiment of the inventive concept and a corresponding touch screen controller.

FIG. 9 is a block diagram of a data processing system incorporating a display device integrated circuit (DDI) according to an embodiment of the inventive concept.

FIG. 10 is a block diagram of a data processing system incorporating a display device integrated circuit (DDI) according to another embodiment of the inventive concept.

FIG. 11 is a block diagram of a data processing system incorporating a display device integrated circuit (DDI) according to yet another embodiment of the inventive concept.

FIG. 12 is a block diagram of a data processing system incorporating a display device integrated circuit (DDI) according to still another embodiment of the inventive concept.

FIG. 13 is a block diagram of a data processing system incorporating a display device integrated circuit (DDI) according to still another embodiment of the inventive concept.

FIG. 14 is a block diagram of a data processing system incorporating a display device integrated circuit (DDI) according to still another embodiment of the inventive concept.

FIG. 15 is a flowchart summarizing a computational transfer of image data including touch icon image data through a data processing system according to an embodiment of the inventive concept.

FIG. 16 a block diagram of a data processing system incorporating a large display according to an embodiment of the inventive concept.

### DESCRIPTION OF EMBODIMENTS

Reference will now be made to certain embodiments illustrated in the accompanying drawings. Throughout the drawings and written description, like reference numbers and labels are used to indicate like or similar elements and features.

It should be noted that the present inventive concept may be embodied in many different forms. Accordingly, the inventive concept should not be construed as limited to only the illustrated embodiments. Rather, these embodiments are presented as teaching examples.

Those skilled in the art will recognize that enumerating terms (e.g., first, second, etc.) are used merely to distinguish between various elements. These terms do not define some numerical limitation on such elements.

As used herein, the term “and/or” includes any and all combinations of one or more of the associated listed elements. It is further understood that when an element is said to be “connected” or “coupled” to another element, it may be directly connected or coupled to the other element, or intervening elements may be present. In contrast, when an element is referred to as being “directly connected” or “directly coupled” to another element, no material intervening elements will be present. Other words used to describe element relationships should be interpreted in a like fashion (e.g., “between” versus “directly between,” “adjacent” versus “directly adjacent,” etc.).

Unless otherwise defined, all terms (including technical and scientific terms) used herein have the same meaning as commonly understood by one of ordinary skill in the art. It is further understood that terms, such as those defined in commonly used dictionaries, should be interpreted as having a meaning that is consistent with their meaning in the context of the relevant art and will not be interpreted in an idealized or overly formal sense unless expressly so defined herein.

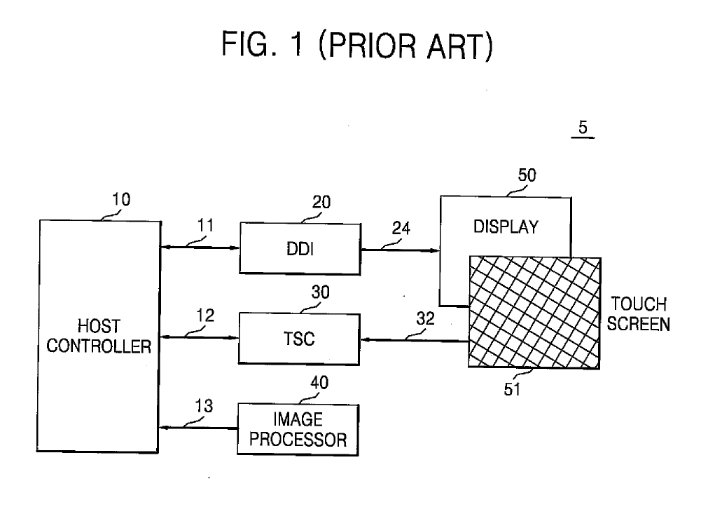

Before considering various embodiments of the inventive concept, the general design and operation of a conventional data processing system will be described as a comparative example. Figure (FIG. 1 illustrates a conventional data processing system 5 including a host controller 10, a display driver integrated circuit (DDI) 20, a touch screen controller (TSC) 30, and an image processor 40. Within the data processing system 5, the DDI 20 is operatively connected to provide display data 24 to a display 50 and TSC 30 is operatively connected to a touch panel 51 overlaying the display 50 and configured to receive sensor data 32 from touch panel 51.

The host controller 10 may take one of many conventionally understood forms. Depending on the nature of the host device incorporating the data processing system 5, the host controller 10 may be a general microprocessor, an application specific integrated circuit (ASIC), or a custom controller. Host controller 10 may be implemented as a single chip integrated circuit or as a set of related chips, and may include components in hardware, firmware and/or software. The control functionality and timing requirements of the data processing system 5 may met by control programming implemented in software or firmware and associated with the host controller 10. Such programming is deemed to be well within ordinary skill in the art.

The functional combination of DDI 20 and display 50, as well as the functional combination of TSC 30 and touch panel 51 may be achieved using many different approaches and components, depending on the specific technology used to implement the display 50 and touch screen 51. The display 50 is be a panel type display such as a Liquid Crystal Display (LCD) panel. The touch screen 51 may be implemented using a variety of touch sensing technologies and associated circuitry. For example, the operative combination of display 50 and touch panel 51 may form a capacitive TSP. Both DDI 20 and TSC 30 are capable of communicating (i.e., receiving and transmitting) low speed serial data (11/12) with the host controller 10 using a competent data communication protocol, such as I²C or similar multiple master protocol.

The sensor data 32 is provided from touch panel 51 to TSC 30 in response to user-defined touch data. Display data 24 is provided from the DDI 20 to the display 50 in response to image data 11 provided by the host controller 10. The primary source of the image data is image processor 40 which may take the form of a conventional graphics processing unit (GPU) or similar graphics/animation engine.

The sensor data 32 provided by touch panel 51 to TSC 30 in response to touch data necessarily includes coordinate data identifying the location(s) on touch panel 51 where the touch data was received. Such coordinate data is commonly expressed as X/Y coordinates in relation to a defined matrix of row and column sensors covering the user interface area of the touch panel 51.

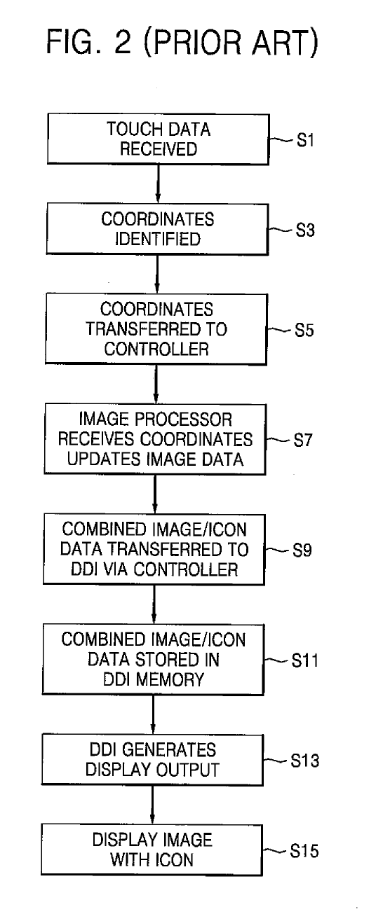

The flowchart shown in FIG. 2 summarizes a method of real-time generating display data from corresponding image data and displaying an image including one or more touch icons on display 50. As a system application (or a portion of a system application) is being executed by the host controller 10, valid touch data is entered via touch panel 51 at a touch icon location. The entry of touch data must be accounted for in the ongoing (real-time) image display. Therefore, the displayed image including all relevant touch icons must be updated to interactively conform with the entered touch data.

With reference to the flowchart of FIG. 2, in response to a user tapping touch panel 51 over a displayed touch icon, touch data is received by the row/column sensor circuitry within the touch panel 51 (S1). As part of conventional touch data detection and interpretation processes performed by touch panel 51 and TSC 30, the sensor data 32 provided by touch panel 51 is resolved to derive coordinate data corresponding to the entered touch data (S3). The coordinate data is then transferred from the TSC 30 to the host controller 10 (S5). The host controller passes the coordinate data to the image processor 40 as part of the received touch data. In response to the received touch data, the image processor 40 updates (i.e., generates a next video frame for) the image data to be displayed on display 50 (S7). Here, it is assumed that the updated image data includes the touch icon data corresponding to the touch icon manipulated by the user. Perhaps, the manipulated touch icon must change a visual characteristics in response to being touched, or the touch icon (or a GUI incorporating the touch icon) must be moved in response to the touch data.

Once the image processor 40 and/or the host controller 10 update the image data to properly include a new or modified touch icon data, the resulting combination of image data and touch icon image data is communicated from the image processor 40 and/or host controller 10 to the DDI 20. The DDI 20 includes a memory adapted to store the combined image data (S11). Within the timing constraints mandated by the real-time animation of the image on the display 50, the DDI 20 provides the stored image data to display 50 as display data (S13). Then, the display 50 conventionally animates the updated image, including the new or modified touch icon among any other changes to the previously displayed image (S15).

In this manner, an image being displayed in real-time on display 50 may interactively response to touch data entered via a corresponding touch panel 51. The arbitrary nature and timing of this user-defined touch data requires the data processing system 5 to continually provide coordinate data corresponding to at least touch icons currently being manipulated. Such coordinate data must necessarily be provided through the TSC 30, but is ultimately received in the image processor 40 and/or host controller 10 in order to generate updated image data.

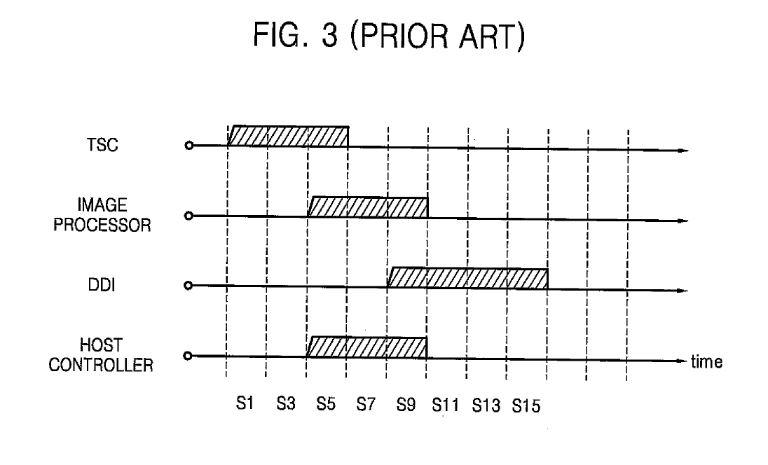

An active resource timing diagram for principle system components is shown in FIG. 3. Thus, FIG. 3 further illustrates the resource loading inherent in the foregoing conventional approach to the real-time provision of image data including touch icon image data in the data processing system 5. As may be seen from FIG. 3, during long portions of the foregoing sequence of method steps, multiple system components are active. Indeed, the host controller 10, TSC 30 and image processing unit 40 are all active during certain portions of the foregoing image data processing method. This coincident operation of principle system components within the data processing system 5 results in high overall current consumption and high peak current consumption. These results are particularly undesirable when data processing system 5 is incorporated into a small, portable, and/or battery-power host device.

In contrast to the foregoing conventional approach, embodiments of the inventive concept seek to reduce the computational burden placed on at least the host controller 10 and also the image processor 40. Embodiment of the inventive concept also seek to reduce the transactional (image data transfer) burdens associated with communicating touch icon image data from the TSC 30 to host controller 10, form host controller 10 to image processor 40, from image processor 40 back to host controller 10, and finally from host controller 10 to the DDI 20. By reducing these computational and transactional burdens, power consumption within the constituent data processing system is reduced, data transfer bandwidth is preserved, and overall data processing time may also be reduced.

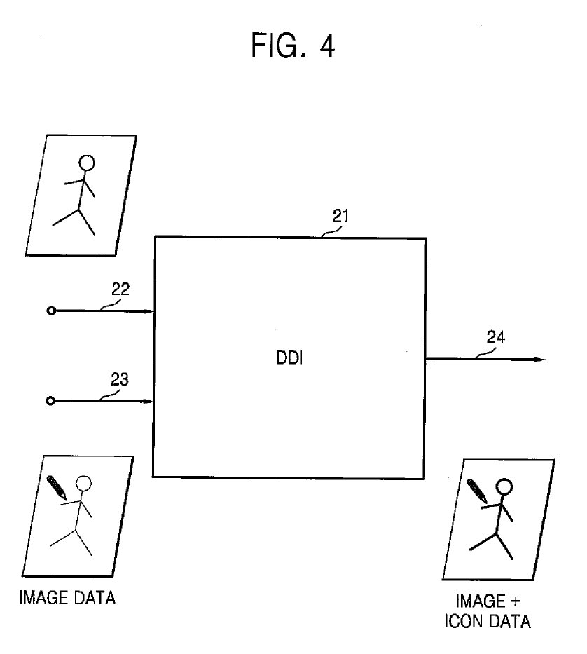

Unlike the conventional DDI 20 described in the data processing system of FIG. 1, a DDI 21 according to an embodiment of the inventive concept and illustrated in block diagram form in FIG. 4 enables improved image data transfer protocols, preserves data transfer bandwidth with a data processing system, and reduces power consumption characteristics for the data processing system. Whereas conventional DDI 20 receives a single source stream of image data from host control 10, DDI 21 receives separate source streams of data. One source stream of data is termed “image data” and the other source stream is termed “touch icon image data.” In the context of certain embodiments of the inventive concept, image data is general term subsuming all data used to animate a final image on a display, excluding only touch icon image data. Touch icon image data is a specific term subsuming at least some portion of the image data used to animate a touch icons with the final image on the display. The combination of image data and touch icon image data forms “display data” which may be communicated from the DDI 21 to display 50 in a conventional manner.

The simple example illustrated in FIG. 4 shows a stick figure being drawn on display using, for example, a conventional drawing application. The drawings application uses a pencil shaped touch icon to identify a current location at which valid touch data may be entered to further the drawing on the display. A user might touch a touch screen associated with the display over the pencil touch icon and move the pencil touch icon in real time around the display. In response to the resulting touch data, a TSC associated with DDI 21 generates the touch icon image data, or some component of touch icon image data, to indicate a current coordinate position for the pencil touch icon. Upon receiving updated image data 22 from (e.g.,) a host controller and touch icon image data 23 from the TSC, the DDI 21 combines (or sums) the respective data streams to yield the display data provided to the display.

In one embodiment of the inventive concept, DDI 21 may replace DDI 20 in the data processing system of FIG. 1. Display 50 may operate in conventional mode in relation to DDI 21 in response to display data 24. However, the transfer of image data (including touch icon image data) and the generation of display data, as between the host controller 10, TSC 30, and DDI 21 must be modified from the conventional approach as described in some additional detail hereafter.

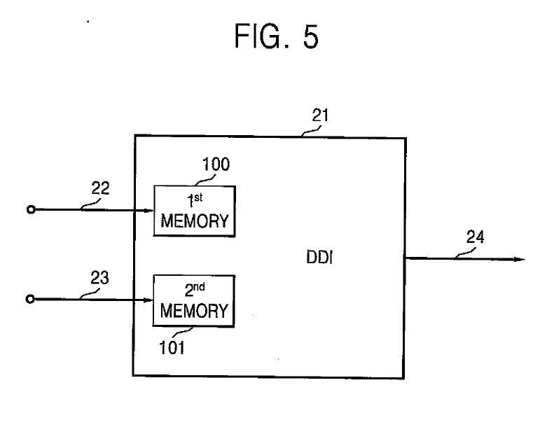

Another embodiment of the inventive concept is illustrated in FIG. 5. In FIG. 5, DDI 21 comprises first and second memories 100 and 101. The first memory 100 is dedicated to the receipt and storage of the image data 22, while the second memory 101 is dedicated to the receipt and storage of at least a portion of the touch icon image data 23. The first memory 100 may be a general memory such as the type currently incorporated within conventional DDIs. However, the second memory 101 provided with the illustrated embodiment of the inventive concept is configured to receive and store only touch icon image data in one or more of its constituent parts from one or more sources potentially including the host controller 10 and TSC 30.

In this context, it should be noted that the touch icon image data may be characterized as including a visual component and a coordinate component. The visual component relates to the graphics (or the data defining the appearance) of a touch icon being displayed. The coordinate component relates to the location of the touch icon on the display and may include, for example, current touch icon coordinates and corresponding next touch icon coordinates. However constituted, at least some portion of the touch icon image data is uniquely stored in the second memory 101 prior to combination with the general image data to generate the display data ultimately communicated to the display within the data processing system.

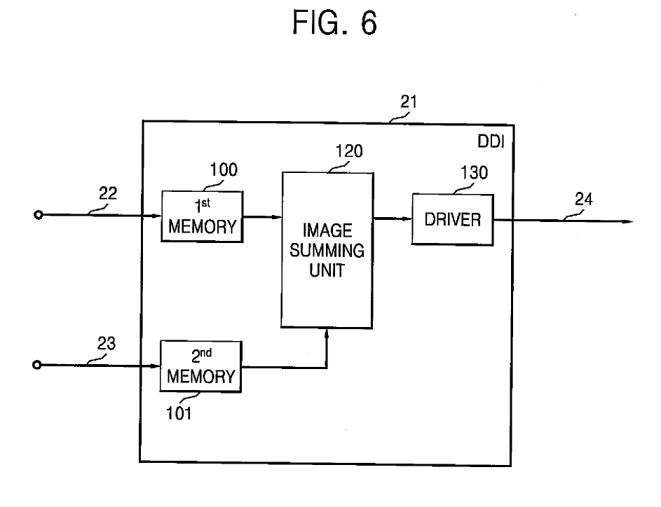

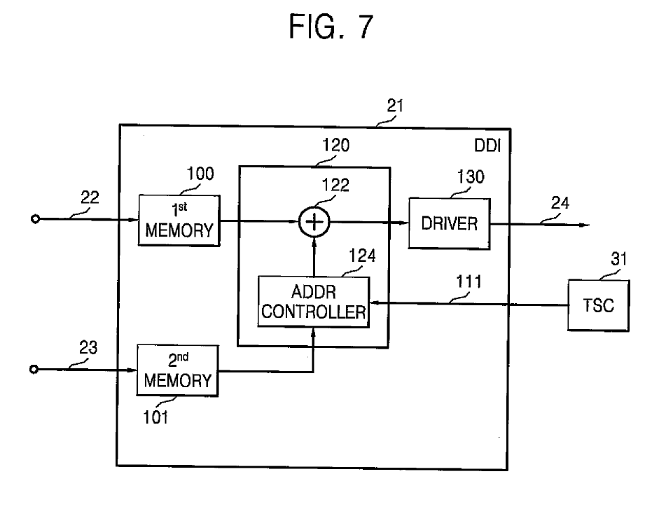

FIGS. 6 and 7 illustrated additional embodiments of the inventive concept. The embodiments shown in FIGS. 6 and 7 extend the foregoing teachings related to the embodiments described in relation to FIGS. 4 and 5.

In FIG. 6, DDI 21 further comprises an image summing unit 120 configured to receive both the image data stored in the first memory 100 and the touch icon image data stored in the second memory 101. DDI 21 also comprises driver 130. The image summing unit 120 may be variously embodied as will be understood by those skilled in the art, but will generally combine the two separately received streams of data to generate the display data 24. The driver 130 may, for example, be a conventional source driver or a conventional gate driver of the type commonly associated with LCD and similar type panel displays.

In FIG. 7, a more particular type of image summing unit 120 is illustrated and comprises an address controller 124 and an image summing circuit 122. The address controller 124 is configured to receive coordinate data associated with a touch icon directly from TSC 31. From the received coordinate data, address controller 124 is able to define, for example, offset information that may be applied to certain “visual” touch icon image data received from the second memory 101. In this context, the coordinate data defines “where” the touch icon should be displayed in the final image, and the visual touch icon image data defines “what” the touch icon will look like (shape, size, color, etc.).

Assuming a touch icon is currently displayed as part of the execution of a system application, the offset information generated by the address controller 124 may be used to move the location of the displayed touch icon consistent with the coordinate data communicated from the TSC 31. At the same time, the visual touch icon image data stored in the second memory 101 is location agnostic, but defines the graphics information used to render the touch icon on a corresponding display. As will be seen hereafter, this ability to separate at least the computation and data transfer functions associated with receipt and use of coordinate data to define the location of a touch icon within a larger image allows the constituent data processing system to generate corresponding visual touch icon image data using a number of different system components. This broader range of system components—beyond the host controller—facilitates the generation of much more visually complex and engaging touch icons without unduly burdening the host controller. This result may be better understood from several embodiments of the inventive concept described hereafter.

At a minimum, the direct transfer of coordinate data from TCS 31 to DDI 21 in the embodiment of FIG. 7 reduces some of the circuitous data transfer burden noted above in relation to the conventional example described in relation to the method summarized in FIG. 2. Thus, in the embodiment of the inventive concept illustrated in FIG. 7, the address controller 124 within image summing unit 120 correlates coordinate data received directly from TSC 31 with visual touch icon image data stored in the second memory 101 in order to generate the touch icon image data applied to the image summing circuit 122. The image summing circuit 122 then integrates or combines the general image data stored in the first memory 100 with the touch icon image data provided by the address controller 124 to generate the display data 24.

Alternately, as suggested by the embodiment of the inventive concept shown in FIG. 6, the coordinate data provided by TSC 31 may be correlated with appropriate visual touch icon image data within host controller 10. That is, offset information may be derived and applied to appropriate visual touch icon image data by host controller 10 instead of address controller 124. The resulting touch icon image data may then stored in the second memory 101 and subsequently combined with the image data stored in first memory 100 within image summing unit 120. This design tradeoff may be made in view of the overall computational burdens placed on the host controller by the system application, and further in view of the other resources available within the data processing system.

The image summing circuit 122 may be variously embodied using conventional circuits. Once the updated (or “new”) coordinates for the touch icon are fixed by operation of host controller 10 or address controller 124, the touch icon image data and image data may be readily combined.

The forgoing embodiments have assumed for the sake of simplicity that the DDI and TSC of a data processing system according to an embodiment of the inventive concept are separate integrated circuits (ICs). However, this need not be the case, and various embodiments of the inventive concept contemplate the combination of the functionality described above in relation to a DDI and a TSC within “a single chip IC”, (i.e., a unitarily fabricated semiconductor device contained within common packaging).

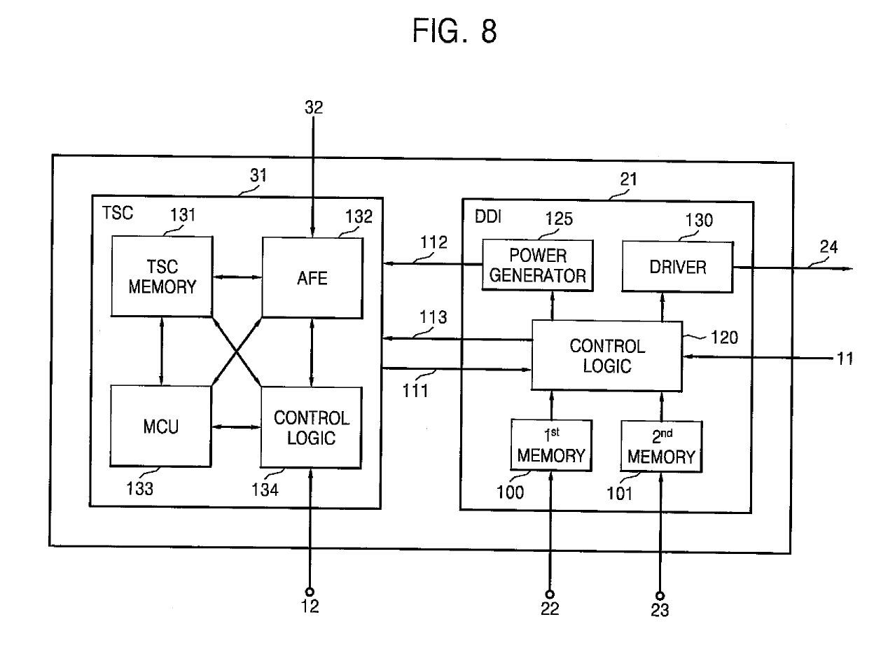

FIG. 8 conceptually illustrates a single chip IC embodiment incorporating a DDI 23 according to an embodiment of the inventive concept with a corresponding TSC 31.

The TSC 31 generally comprises certain analog front end (AFE) circuitry 132 configured to receive the sensor data 32 from a corresponding touch screen, a TSC memory 131, a micro controller unit (MCU) 133, and corresponding control logic 134. Control logic 134 is configured to receive, for example, a low speed serial input from host controller 10. As described in relation to FIG. 7, TSC 31 provides coordinate data 111 to DDI 23. The foregoing TSC circuit blocks may be designed and implemented using conventionally understood principles and techniques.

Within the single chip IC embodiment of FIG. 8. the DDI 23 comprises in addition to first memory 100, second memory 101, control logic 120 and driver 130, a power generation circuit 125. Power generation circuit provides various power signals 112 to TSC 31. Further, DDI 23 also provides various timing 113 signals to TSC 31, including, for example, a pixel clock signal, delay line selection signals (Hsync), a frame signal (Vsync), etc.

The single chip IC embodiment shown in FIG. 8 further reduces overall current consumption when incorporated into various embodiments of the inventive concept, and may also reduce the cost and size of incorporating host devices given the economies of scale provided by a single chip IC embodiment of two data processing system components formerly provided in separate IC packaging.

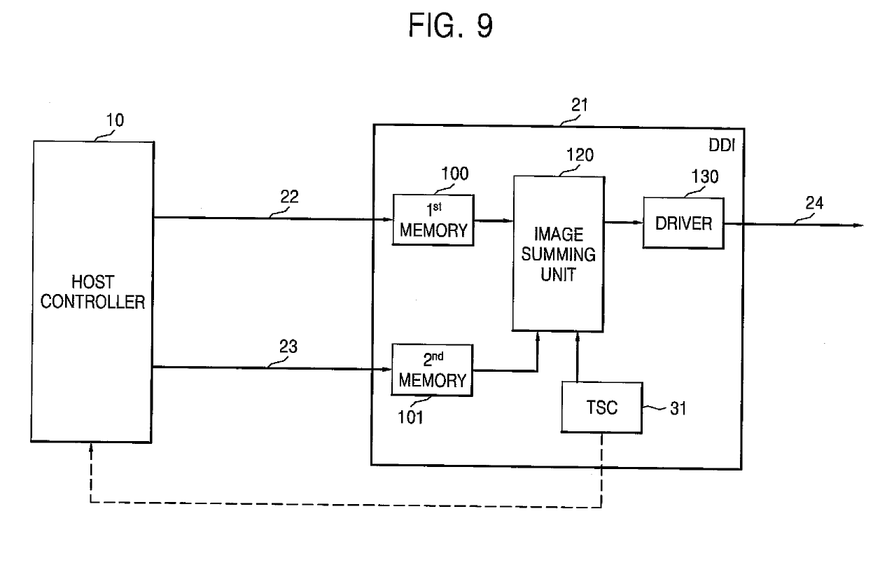

FIG. 9 illustrates another embodiment of the inventive concept and summarizes several of the concepts described above. In FIG. 9, the host controller 10 provides image data 22 to the first memory 100 and at least a portion of the touch icon images data to the second memory 101 (e.g., the visual touch icon image data portion). The TSC 31 may directly transfer coordinate data related to one or more touch icons to the image summing unit 120 of DDI 21. Alternately or additionally, as indicated by the dotted line, the coordinate data may be transferred to the host controller 10. Depending on the system designer's desired allocation of computational burden between host controller 10 and image summing unit 120, either the host controller 10 or the image summing unit 120 will correlate the coordinate data derived from the sensor data received by TSC 31 with visual touch icon image data in order to generate the required touch icon image data. However, in every instance the image summing unit 120 will operate to combine the image data stored in the first memory 100 with the touch icon image data, whether the touch icon image data is generated by the host controller 10 and stored in the second memory 101 or is ultimately generated within the image summing unit 120.

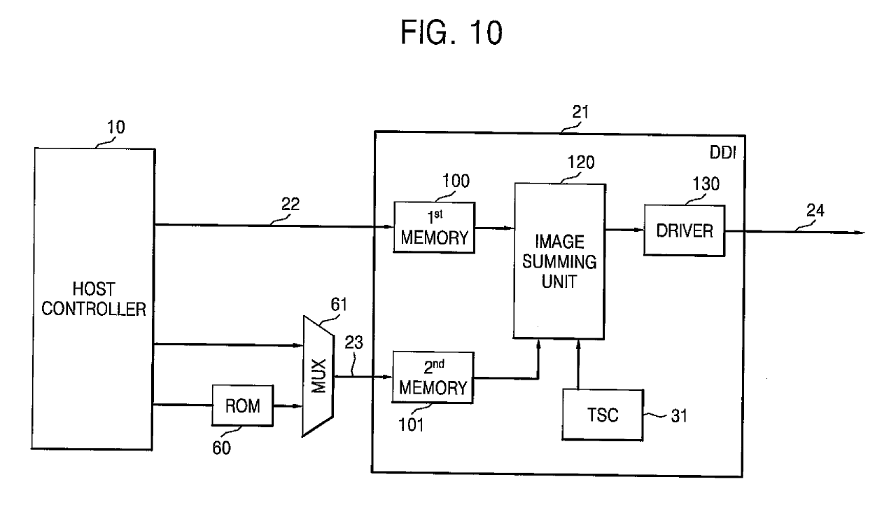

Embodiments of the inventive concept allow at least the visual touch icon image data portion of the touch icon image data (i.e., the portion of the touch icon image data excluding the coordinate data) to be variously provided by sources other than or in addition to the host controller 10. FIG. 10 illustrates yet another embodiment of the inventive concept, wherein either host controller 10 or a non-volatile memory (NVM) 60 may serve as the source of the visual touch image data. Either source may be selected via a multiplexer (MUX) 61 under the control of host controller 10 to provide the visual touch image data to the second memory 101.

For example, when certain standard or nominal touch icons are displayed during execution of a system application, such standard touch icons may have respective visual touch icon image data portions stored and indexed within the NVM 60. Host controller 10 may then routinely “call-up” desired visual touch icon image data from NVM 60 and transfer it to the second memory 101 through MUX 61. However, when a system application requires a non-standard touch icon, such as a customized or conditional touch icon, it may be generated by the host controller 10. In this manner, rather than being limited to only a preset catalog of visual touch icon image data stored within NVM 60, the host controller 10 may generate any reasonable type of visual touch image icon data and transfer it to the second memory 101 via MUX 61. Thus, the embodiment of the inventive concept illustrated in FIG. 10 is able to provide a very broad range of touch icons including specialized or customizable touch icons, while at the same time efficiently providing the visual touch icon image data necessary to render certain standard touch icons.

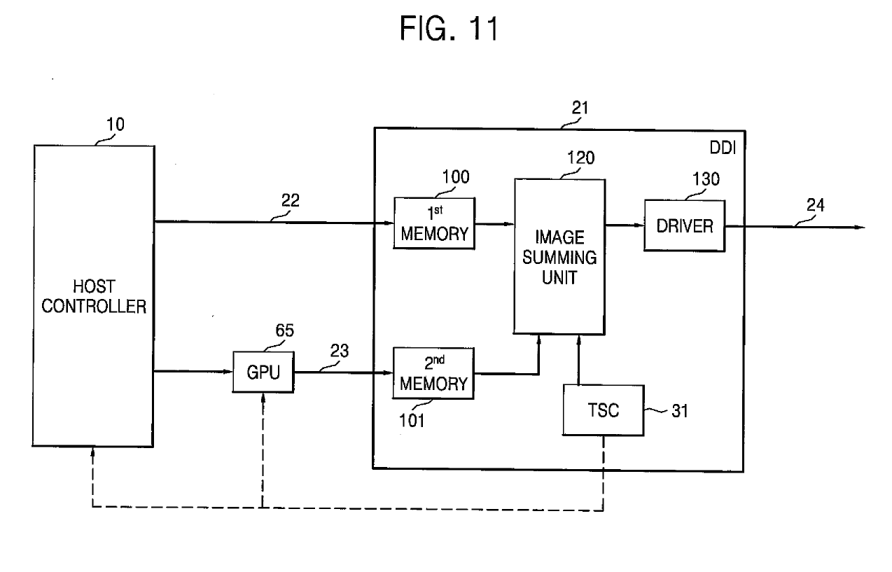

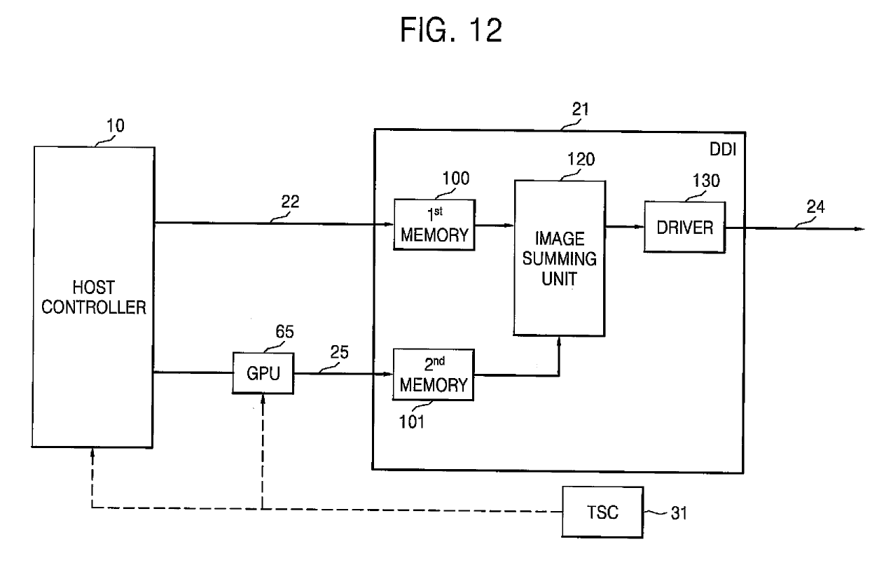

The embodiments of the inventive concept illustrated in FIGS. 11 and 12 extend the foregoing teachings by replacing the NVM 60, MUX 61 and the computational requirements placed on the host controller 10 to generate customized visual touch icon image data with a graphics engine (GPU) 65. Many contemporary data processing systems include a variety of graphics engines of varying levels of sophistication. Thus, a data processing system resource, already optimized to the generation of image data including, as needed, visual touch icon image data may be present in certain host device including an embodiment of the inventive concept. Accordingly, a data processing system including graphics engine 65 may use to the computational capabilities of the graphics engine to render touch icons.

The embodiment of the inventive concept illustrated in FIG. 11 assumes a single chip embodiment of TSC 31 and DDI 21, wherein TSC 31 directly provides coordinate data to one or more of host controller 10, graphics engine 65 and/or image summing unit 120. Graphics engine 65 provides the visual touch icon image data to the second memory 101.

In contrast, the embodiment of the inventive concept illustrated in FIG. 12 assumes a physically separate TSC 31 that transfers coordinate data to at least one of the host controller 10 and the graphics engine 65, but not directly to the image summing unit 120. The functional and computational combination of the graphics engine 65 and host controller 10 may be used to generate the touch icon image data subsequently transferred to the second memory 101.

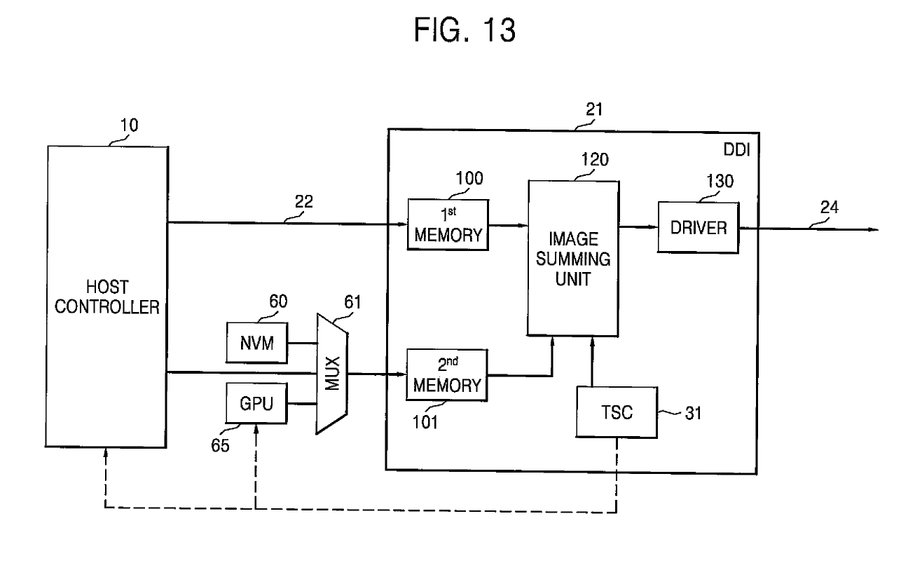

The embodiment of the inventive concept illustrated in FIG. 13 shows multiple potential sources of touch icon image data (or at least the visual portion of the touch icon image data), including host controller 10, NVM 60, and graphics engine 65 all selectively connected to the second memory 101 via MUX 60. Here again, TSC 31 may transfer coordinate data associated with a touch icon being displayed to one or more of the image summing unit 120, host controller 10 and/or graphics engine 65.

In the foregoing embodiments, the NVM 60 may take one of many different forms including a Read Only Memory (ROM), an electrically programmable ROM (EPROM), a flash memory, a phase memory, and/or various forms of resistive memory, etc. A multiplexer has been used to illustrate one type of switching circuit that may be used to selected between multiple sources of touch icon image data or visual touch icon image data. Those skilled in the art will recognize that a host of commercially available and conventionally understood equivalent circuits may be used as replacements for MUX 60.

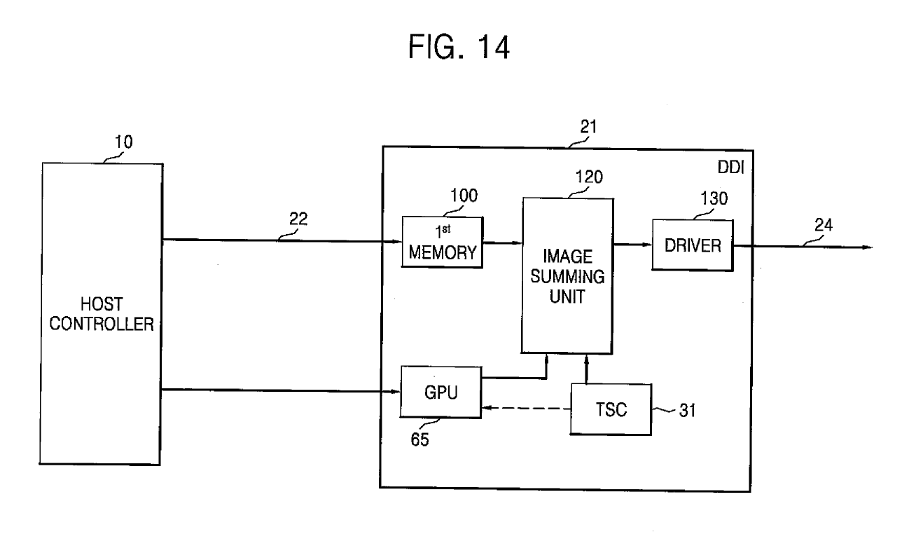

The embodiment of the inventive concept illustrated in FIG. 14 further integrates the graphics engine 65 within a single IC embodiment along with DDI 21 and TSC 31. It is presently contemplated that ongoing improvements in semiconductor design and fabrication technology will enable this type of “system level” integration in the future. For example, emerging GPUs may incorporate the functionality current ascribed to the DDI and TSC devices discussed above. Embodiments of the inventive concept incorporating a graphics engine capable of real-time graphics generation will allow the use of an increasingly sophisticated class of touch icons. Many smaller, lower powered, or less costly embodiments of the inventive concept will not benefit from this level of integration, since they do not require the additional computational capabilities. Yet, many other embodiments of the inventive concept will benefit.

Accordingly, contemporary dual (or multi) core processors may readily enable the functionality described. That is, one processing core might be used to provide the functionality ascribed above to a host controller, while another processing core might simultaneously provide the functionality described above in relation to a single chip DDI/TSC or a GPU incorporating both DDI and TSC capabilities.

Various hardware, firmware and/or software components may be combined to implement the components of a data processing system according to an embodiment of the inventive concept. The foregoing embodiments have been described at a block level of detail to avoid confusing detail and in recognition of the fact that many different hardware/firmware/software combinations may be used to obtain the described functionality.

In relation to the foregoing embodiments, various methods of displaying an image including a touch icon may be realized. At previously noted any type of touch screen enabled display is susceptible to the benefits provided by embodiments of the inventive concept. Constituent displays or display panels within these touch screen enabled displays may be implemented using LCD, OLED, PDP, and/or LED technologies. Displays incorporating capacitive touch screens are deemed particularly well suited for adaptation or modification according to the foregoing principles and teachings. Embodiments of the inventive concept may include contemporary displays having overlaying touch screens or emerging displays having integrated touch screens.

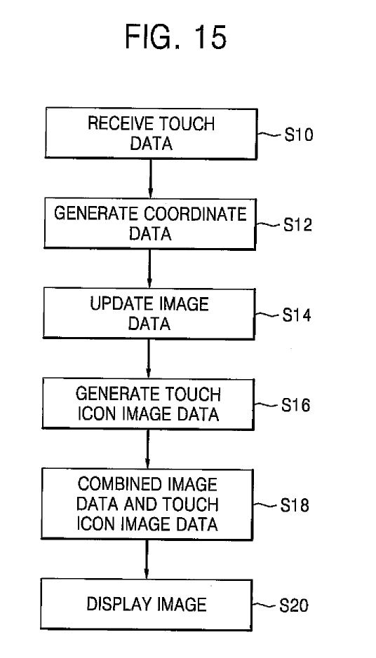

One method embodiment of the inventive concept is summarized in the flowchart of FIG. 15 which is described below in the context of data processing systems like the one shown in FIG. 9. Within this method, user-defined touch data is first received via a touch screen enabled display (S10). The touch data is assumed to be entered in relation to a displayed touch icon. Clearly, multiple touch icons may be displayed, but only a single icon is described for the sake of simplicity. One or more touch icons having any reasonable level of complexity are contemplated by method embodiments of the inventive concept.

Once received, the touch data is used to derived corresponding coordinate data (S12). Coordinate data associated with the touch icon is usually derived within the TSC 31 and may thereafter be provided to the host controller 10 and/or image summing unit 120.

Updated image data (e.g., a next frame of image data, excluding only the touch icon image data) is generated by the host controller 10 and provided to first memory 100 (S14). In contrast, the touch icon image data is either (1) generated by the host controller 10 in response to the coordinate data received from TSC 31, or (2) generated within image summing unit 120 in response to coordinate data received from TSC 31 and visual touch icon image data received from host controller 10 (or alternately a non-volatile memory, or alternately a graphics engine) (S16).

Once the image data is stored in first memory 100 and the touch icon image data is stored in the second memory or generated by the image summing unit 120, the image data and touch icon image are combined in image summing unit 120 (S18). Finally, an image defined by the combined image data and touch icon image data is displayed (S20).

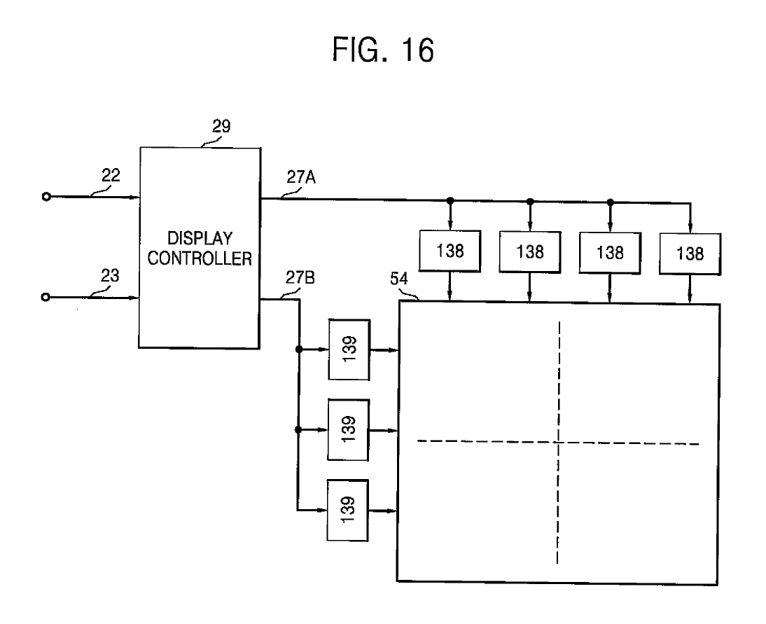

Many of the benefits inherent in the foregoing embodiments have been described in relation to smaller, portable electronic devices. Yet, the scope of the subject inventive concept is not limited to only mobile or battery-powered devices incorporating a data processing system. The embodiment of the inventive concept illustrated in FIG. 16 is drawn to a data processing system incorporating a large display 54. Large display 54 may be a capacitive touch screen panel implemented by the mechanical assembly of multiple touch screen panel sections. This type of touch screen enabled display is disclosed in U.S. patent application Ser. No. 12/635,870 filed Dec. 11, 2009, the subject matter of which is hereby incorporated by reference.

To avoid confusion the integrated circuit functioning as the master display device (or master DDI type device) in the illustrated embodiment of FIG. 16 will be referred to as a “display controller” 29. Similar to the foregoing, display controller 29 receives separate streams of image data 22 and touch icon image data 23 and combines the two data streams to generate display data 27A and 27B, respectively supplied to the collection of drivers 138 and 139. The plurality of drivers 139 may take the form of row drivers or gate drivers, such as those conventionally used in panel type display devices. The plurality of drivers 138 may take the form of column drivers or source drivers, such as those conventionally used in panel type display devices.

Many data processing systems incorporating relatively large displays such as the one shown in FIG. 16 will not be overly concerned with power consumption. Yet, various embodiments of the inventive concept still allow a significant computational burden to shifted from and the constituent host controller. This option of shifting part of the computational burden from a host controller to the display controller 29 in relation to the update and integration of touch icon image data reduces some of the data transfer delays associated with conventional approaches. Such shifting of computational burden and associated data transfer requirements are particularly beneficial where display controller 29 is a single IC embodiment including both master DDI and TSC functionalities, or where the master DDI functionality subsumed within an enhanced graphics engine.

The foregoing notwithstanding, emerging portable devices, such as tablet PCs for example, may include significantly larger touch screen enabled displays, and may be implemented in a manner consistent with the foregoing embodiments of the inventive concept. Thus, the benefits of the inventive concept extend across a broad range of data processing systems and consumer electronics, including small handheld device with touch screen enabled displays to large workstation displays similarly enabled to receive user defined touch data.

While exemplary embodiments have been particularly shown and described above, it is understood that various changes in form and detail may be made therein without departing from the scope of the following claims.

1-19. (canceled)

20. A data processing system, comprising:
a touch screen panel configured to receive a touch input;
a host controller configured to generate an image data; and
a display driver integrated circuit (DDI) configured to generate a display data by combining the image data with a touch icon image data defining the touch icon image in response to the touch input.

21. The data processing system of claim 20, further comprising:
a touch screen controller (TSC) configured to receive a touch signal from the touch screen panel and generate a coordinate data identifying a location of the touch input on the touch screen panel,
wherein the host controller is further configured to receive the coordinate data and generate the touch icon image data in response to the coordinate data.

22. The data processing system of claim 21, wherein the display driver IC comprises:
a first memory storing the image data received from the host controller;
a second memory storing the touch icon image data received from the host controller; and
an image summing unit configured to receive and combine the image data from the first memory and the touch icon image data from the second memory.

23. The data processing system of claim 20, further comprising:
a touch screen controller (TSC) configured to receive a touch signal from the touch screen panel and generate a coordinate data identifying a location of the touch input on the touch screen panel; and
a graphics engine configured to receive the coordinate data and generate the touch icon image data in response to the coordinate data.

24. The data processing system of claim 20, further comprising:
a touch screen controller (TSC) configured to receive a touch signal from the touch screen panel and generate a coordinate data identifying a location of the touch input on the touch screen panel,
wherein the display driver IC (DDI) comprises:
a first memory storing the image data received from the host controller;
a second memory storing the touch icon image data; and
an image summing unit configured to receive and combine the image data from the first memory with the touch icon image data.

25. The data processing system of claim 24, wherein the DDI further comprises; a driver configured to receive the combined image data and generate the display data.

26. The data processing system of claim 25, wherein the image summing unit comprises:
an address controller configured to receive and correlate the coordinate data with the touch icon image data received from the second memory to generate the movement of the touch icon image data; and
an image summing circuit configured to receive and combine the image data from the first memory and the touch icon image data from the address controller.

27. The data processing system of claim 26, wherein the DDI further comprises; a driver configured to receive the combined image data and generate the display data.

28. The data processing system of claim 21, wherein the DDI and TSC are implemented as a single chip integrated circuit (IC).

29. A data processing system, comprising:
a display panel incorporating a touch screen panel configured to receive a touch input;
a host controller configured to generate a image data;
a display controller configured to generate a combined image data of the image data and a touch icon image data;
a first plurality of drivers arranged on one side of the display panel and configured to receive the combined image data and generate a display data, and a second plurality of drivers arranged on another side of the display panel.

30. The data processing system of claim 29, wherein each one of the first plurality of drivers is a source driver, and each one of the second plurality of drivers is a gate driver.

31. The data processing system of claim 29, wherein the display panel is a Liquid Crystal Display (LCD) panel or Plasma display panel (PDP).

32. The data processing system of claim 29, further comprising:
a touch screen controller (TSC) configured to receive a touch input from the touch screen panel and generate a coordinate data identifying a location of the touch input on the touch screen panel,
wherein the host controller is further configured to receive the coordinate data and generate the touch icon image data in response to the coordinate data.

33. The data processing system of claim 29, wherein the display controller comprises:
a first memory storing the image data received from the host controller;
a second memory storing the touch icon image data received from the host controller; and
an image summing unit configured to receive and combine the image data from the first memory and the touch icon image data from the second memory.

34. The data processing system of claim 29, further comprising:
a touch screen controller (TSC) configured to receive a touch signal from the touch screen panel and generate a coordinate data identifying a location of the touch input on the touch screen panel; and
a graphics engine configured to receive the coordinate data and generate the touch icon image data in response to the coordinate data.

35. The data processing system of claim 29, further comprising:
a touch screen controller (TSC) configured to receive a touch signal from the touch screen panel and generate a coordinate data identifying a location of the touch input on the touch screen panel,
wherein the display controller comprises:
a first memory storing the image data received from the host controller;
a second memory storing touch icon image data; and
an image summing unit configured to receive and combine the image data from the first memory with the touch icon image data.

36. The data processing system of claim 29, wherein the display panel comprises multiple touch screen panel sections mechanically assembled to form a large unitary user interface area.

37. The data processing system of claim 29, wherein the display panel comprises a capacitive type touch screen panel.

38. The data processing system of claim 30, wherein the display controller and the touch screen controller are implemented as a single chip integrated circuit (IC).

39. The data processing system of claim 30, further comprising:
a touch screen controller (TSC) configured to receive a touch in signal from the touch screen panel and generate a coordinate data identifying a location of the touch data input on the touch screen panel,
wherein the host controller is further configured to receive the coordinate data and generate the touch icon image data in response to the coordinate data.

40. The data processing system of claim 39, the each one of a plurality of the source drivers and the touch screen controller are implemented as a single chip integrated circuit (IC).
